(19) United States
(12) Patent Application Publication
(10) Pub. No.: US 2006/0123633 A1
(43) Pub. Date: Jun. 15, 2006

(54) Apparatus comprising a button and a part adjustable by the button

(75) Inventor: Andreas Hauer, Klagenfurt (AT)

Correspondence Address: CORPORATE PATENT COUNSEL;U.S. PHILLIPS CORPORATION, 580 WHITE PLAINS ROAD, TARRYTOWN, NY, 10591, US

(73) Assignee: KONINKLIJKE PHILIPS ELECTRONICS N.V.

(21) Appl. No.: 10/470,626

(22) Filed: Jun. 22, 2004

(30) Foreign Application Priority Data
Oct. 18, 2001 (EP) 01 000 541.1

(51) Int. Cl. B26B 19/00

(52) U.S. Cl. 30/201

(57) ABSTRACT

In an apparatus (1) having an adjustable adjustment slider (13) and having a second part (9) provided for adjusting the adjustment slider (13), provision is made for at least one coupling counterpart (16) to be present in the adjustment slider (13) and for the second part (9) to have a coupling piece (31) that can be coupled to the coupling counterpart (16) so that, when the second part (9) is not actuated, the coupling piece (31) is uncoupled from the coupling counterpart (16) in the adjustment slider (13) and, by actuating the second part (9), can be coupled to the coupling counterpart (16) to enable the adjustment slider (13) to be adjusted.

The invention relates to an apparatus having at least one adjustment slider displaceably guided along a first path of movement and having at least one second part of the apparatus that is provided for adjusting the adjustment slider, which second part is adjustably guided along a second path of movement and can be actuated and adjusted along the second path of movement by hand.

An apparatus of the type defined in the opening paragraph is known from the patent document U.S. Pat. No. 5,898,999 A, for example. This known apparatus is a hair-cutting system that is equipped with an adjustable comb device. To adjust the comb device, the known apparatus has two adjustment sliders adjustably guided along a first path of movement, the two adjustment sliders each being hinged by a permanently made hinge joint to a sliding button that is provided as a second component part of the apparatus. In the known apparatus, the two adjustment sliders and the sliding button are thus coupled to one another permanently. The consequence of this is that the sliding button provided as the second component part and the two adjustment sliders can only be adjusted over almost the same adjusting travel. Since a relatively large adjusting travel is required, and is therefore provided, for the adjustable comb device, an equally large adjusting travel has to be provided for the sliding button, the result of which is that it is relatively costly and complicated to obtain a good seal for the opening that is provided through the housing of the known hair-cutting apparatus to allow the sliding button to be adjusted, the purpose of the seal being to prevent any unwanted ingress of dust or dirt into the interior of the apparatus. In the case of the known apparatus the sliding button is fitted with a pushbutton built into the sliding button, which pushbutton is intended as a locking means and can be used to stop any unintentional displacement of the sliding button. This construction is relatively costly and complicated. The circumstances described above are susceptible of improvement.

It is an object of the invention to find a mechanically simple, reliable and cost-effective solution for the above-described circumstances susceptible of improvement and to provide an improved apparatus of the type detailed above in the opening paragraph.

To achieve the object detailed above, features according to the invention are provided in an apparatus according to the invention, thus enabling an apparatus according to the invention to be characterized in the following manner, namely:

An apparatus having at least one adjustment slider displaceably guided along a first path of movement and having at least one second part of the apparatus that is provided for adjusting the adjustment slider, which second part is adjustably guided along a second path of movement and can be actuated and adjusted along the second path of movement by hand, wherein said second part has a coupling piece that is adjustable towards the adjustment slider and can be coupled directly to the adjustment slider, and wherein the adjustment slider has at least one coupling counterpart that is configured for direct coupling to the coupling piece of the second part and wherein, when the second part is not actuated, the coupling piece of the second part and the at least one coupling counterpart of the adjustment slider are uncoupled from one another, and wherein, when the second part is actuated, the coupling piece of the second part adjusted towards the adjustment slider as a result of the actuation is directly coupled to a coupling counterpart in the adjustment slider, and the adjustment slider can be adjusted along the first path of movement by means of the coupling piece of the second part of the apparatus, which coupling piece has been adjusted towards the adjustment slider and directly coupled to the coupling counterpart of the adjustment slider.

By providing the features according to the invention, it is possible to produce an apparatus that can manage with an adjusting travel for the second part that is considerably smaller that the adjusting travel required for the adjustment slider in a structurally simple and space-saving manner and at only a low cost. In addition, the features according to the invention render it possible in a particularly simple way for unintentional or unwanted adjustment of the adjustment slider to be prevented.

It may be mentioned that a beard trimming or hair-cutting apparatus has been put onto the market under the Panasonic brand name with type number ER215, in which a displaceably guided adjustment slider is provided for adjusting a comb device and in which two pushbuttons, each forming a second part of the apparatus, are provided for adjusting the adjustment slider. In this case the adjustment slider is formed partly as a rack with which a gear meshes, this gear being co-axially connected to an adjusting gear. The adjusting gear has successive alternating indentations and projections along its circumference, thus forming a set of adjusting teeth. The two pushbuttons mentioned above are arranged opposite the adjusting gear substantially in mirror symmetry to one another, and each of the two pushbuttons has an adjusting tooth mounted on an arm that can be extended laterally in relation to the adjusting gear such that each of the two adjusting teeth is arranged and intended for cooperation with the set of adjusting teeth, and the adjusting gear can be turned step by step, in opposite directions of rotation, by each of the two adjusting teeth, thus allowing the rack, and hence the adjustment slider, to be moved in opposite directions via the gear that is coaxially connected to the adjusting gear. Although it is also possible with this solution, by repeated actuation of a pushbutton, to obtain for the adjustment slider an adjusting travel that is greater than the adjusting travel of the pushbutton while having a relatively small adjusting travel for each pushbutton, there is no provision for any direct coupling of either of the pushbuttons provided as second parts of the apparatus to the adjustment slider, nor is this possible, and instead, to achieve the result in question, a solution is provided that is both relatively complicated in terms of structural design and requires a relatively large number of components and that calls for a relatively complicated assembly process, because all the mutually cooperating components have to be fitted in exact positions relative to one another if there is to be any guarantee of satisfactory operation. By contrast, in a solution according to the invention it becomes possible for the structural implementation to be considerably more simple because the manually adjustable second part can be coupled directly to the adjustment slider, which is an advantage not only with regard to simple construction but also with regard to safe and reliable adjustment of the adjustment slider by means of the second part.

In an apparatus according to the invention, the adjustment slider may have, for example, only two coupling counterparts situated next to one another. However, it was found to be particularly advantageous if, in addition, the steps defined in claim 2 are taken. It becomes possible in this way to manage with an especially small adjusting travel for the second part.

In an apparatus according to the invention as specified above, it was found to be particularly advantageous if, in addition, the features defined in claim 3 are provided. This is advantageous with regard to particularly safe and reliable operation because an exactly defined adjusting travel is set for the second part with the help of the limiting means.

In an apparatus according to the invention as specified above, it was also found to be highly advantageous if, in addition, the features defined in claim 4 are provided. A construction of this kind has proved to be advantageous in respect of simple and convenient handling because it brings with it an assurance that the second part will automatically return to its starting position once it has been adjusted and then released.

In an apparatus according to the invention it was been found to be particularly advantageous if, in addition, the features specified in claim 5 are provided. A construction of this kind has proved to be particularly advantageous because it provides a guarantee that any movement of the adjustment slider will definitely be prevented when the adjustment slider and the second part are uncoupled from one another.

In an apparatus according to the invention it was also found to be advantageous if, in addition, the steps specified in claim 6 or the steps specified in claim 7 are taken. A particularly simple structural implementation becomes possible in this way, because all that are needed to control the locking means are means that are present anyway.

In an apparatus according to the invention it was also found to be advantageous if, in addition, the features specified in claim 8 are provided. A construction of this kind, which can be considered as known per se, has also proved to be advantageous for an apparatus according to the invention, because it makes the apparatus particularly easy to handle.

The aspects mentioned above and other aspects of the invention are apparent from and will be elucidated with reference to the embodiments described hereinafter.

The invention will be described in more detail below with reference to three embodiments shown in the drawings to which, however, the invention is not limited.

FIG. 1 is an oblique view from above of an apparatus in accordance with a first embodiment of the invention.

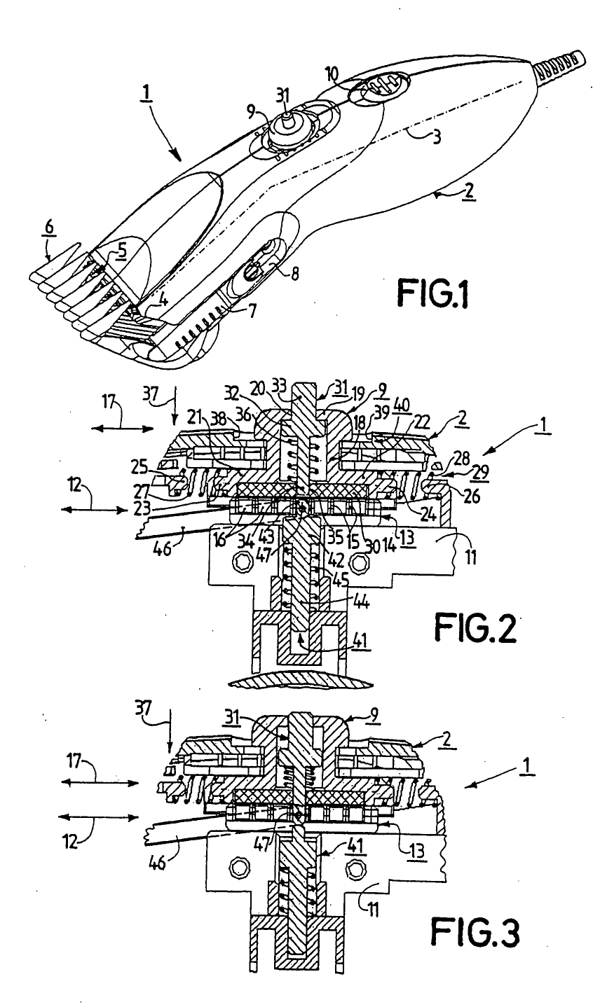

FIG. 2 is a sectional view of a detail of the apparatus shown in FIG. 1 in a first operating situation.

FIG. 3 is a view similar to FIG. 2, showing the same detail as FIG. 2 but in a second operating situation.

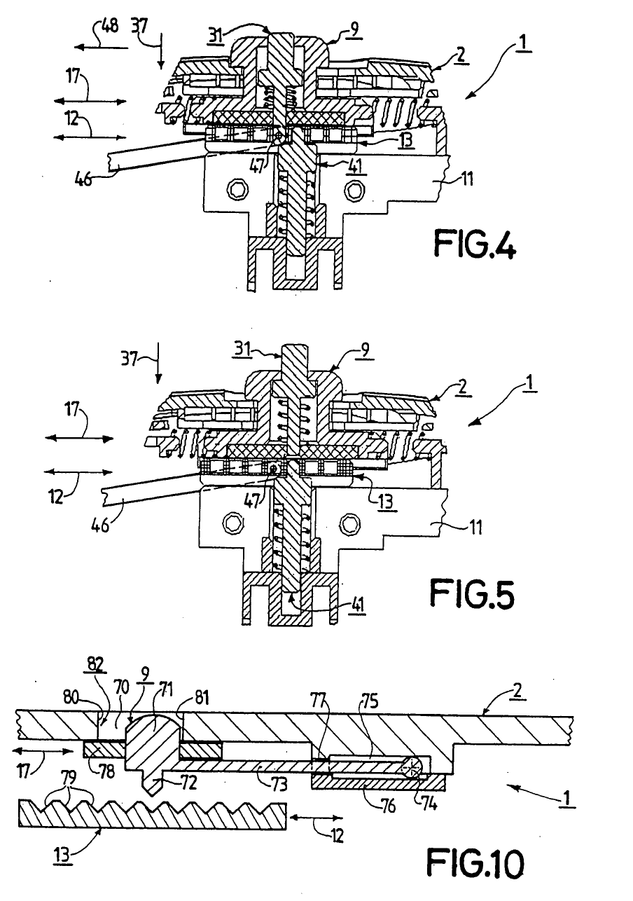

FIG. 4 is a view similar to FIGS. 2 and 3, showing the same detail as FIGS. 2 and 3 but in a third operating situation.

FIG. 5 is a view similar to FIGS. 2, 3 and 4, showing the same detail as FIGS. 2, 3 and 4 but in a fourth operating situation.

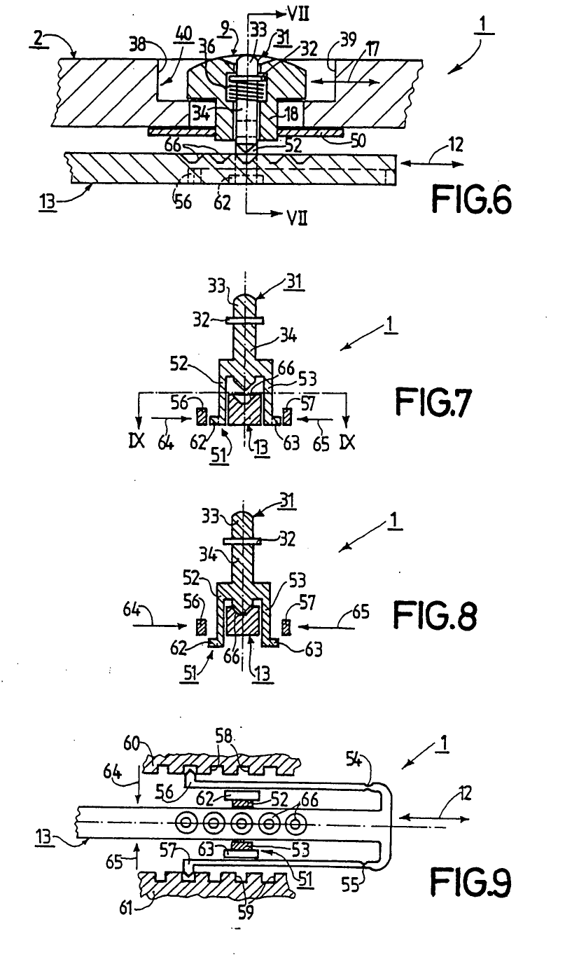

FIG. 6 is a diagrammatic sectional view showing a detail essential to the invention of an apparatus in accordance with a second embodiment of the invention.

FIG. 7 is a sectional view taken on the line VII-VII in FIG. 6 showing a detail including a pushbutton type coupling slider, where the connection slider is not operated.

FIG. 8 is a view similar way to FIG. 7, showing the same detail as FIG. 7 but where the coupling slider is operated.

FIG. 9 is a sectional view on line IX-IX in FIG. 7 showing a further detail of the second embodiment of the apparatus.

FIG. 10 is a diagrammatic sectional view showing a detail essential to the invention of an apparatus in accordance with a third embodiment of the invention.

FIG. 1 shows an apparatus 1 that is a hair-cutting apparatus. The hair-cutting apparatus 1 has a housing 2 that is arranged to be angled in the way indicated by the center line 3 that is shown as a dot-dash line in FIG. 1. In the area of a front end 4 of the housing 2, the apparatus 1 is provided with a toothed cutting device 5 for cutting hair. To enable the hairlength cut during a hair-cutting operation to be set, the apparatus 1 has, in the area of the front end 4 of the housing 2, a comb device 6 in addition to the toothed cutting device 5. The comb device 6 can be displaced relative to the housing 2, and hence relative to the toothed cutting device 5, with the aid of two guide arms 7 that can each be displaced in a guide channel 8 in the housing 2. To allow the comb device 6 to be displaced, the apparatus 1 has a sliding button 9. To allow it to be switched on and off, the apparatus 1 has a further sliding button 10.

With regard to the construction of apparatus 1, reference is made at this point to U.S. Pat. No. 5,898,999 A. This document also describes a hair-cutting apparatus, and the construction of this apparatus is very similar to that of the apparatus 1 shown in FIG. 1. The reference to U.S. Pat. No. 5,898,999 A is deemed to incorporate the disclosure thereof herein by reference.

The adjustment of the comb device 6 with the help of the sliding button 9 will be described in detail below with reference to FIGS. 2 to 5.

Inside its housing 2, the apparatus 1 has a base part 11 that is held stationary in the housing 2 in a manner that is not shown in detail, said base part 11 being provided to hold various parts of the apparatus 1. The apparatus 1 also has an adjustment slider 13 that is adjustably guided on base part 11 along a first path of movement indicated by a double-headed arrow 12. Adjustment slider 13 has two side walls 14, of which only one can be seen in FIGS. 2 to 5. The two side walls 14 are connected together by a total of eight (8) crosspieces 15. A total of seven (7) chambers 16 are provided between the crosspieces 15. Each of these chambers 16 forms a coupling counterpart 16 in the adjustment slider 13. The purpose of the chambers 16 is explained in more detail below.

In the apparatus 1, the sliding button 9 forms a second part 9 that is provided to allow the adjustment slider 13 to be adjusted. The sliding button 9 is adjustably guided along a second path of movement indicated by a double-headed arrow 17. In the present case the first path of movement indicated by double-headed arrow 12 and the second path of movement indicated by double-headed arrow 17 extend parallel to one another. This is not absolutely essential because the two paths of movements may alternatively extend at a slight angle to one another. The sliding button 9 can be operated and adjusted along the second path of movement indicated by double-headed arrow 17 by hand.

The sliding button 9 comprises a sleeve-like section 18 that is closed off by a cover section 19 at the end remote from the interior of the apparatus, a passage 20 being provided in the cover section 19. In the area of the sliding button 9 remote from the cover section 19, a first extension 21 and a second extension 22 project laterally from the sleeve-like section 18 of the button. A first projection 23 extends from the first extension 21 and a second projection 24 extends from the second extension 22. Situated opposite the first projection 23 is a first opposing projection 25 that is arranged to be stationary in the apparatus 1. Situated opposite the second projection 24 is a second opposing projection 26, which is likewise arranged to be stationary in the apparatus 1. A first compression spring 27 is provided between the first projection 23 and the first opposing projection 25, and a second compression spring 28 is provided between the second projection 24 and the second opposing projection 26. The first compression spring 27 and second compression spring 28 form spring means 29 that cooperate with the sliding button 9 and load the sliding button 9 to a starting position that is defined for the sliding button 9 in the apparatus 1. The starting position of the sliding button 9 can be seen in FIGS. 2 and 5. In the present embodiment the spring means 29 are in the form of two compression springs 27 and 28. Instead of two compression springs, other springs may alternatively be provided such as, for example, tension springs or even rod springs. It should also be noted that the sliding button 9 is closed off in the area remote from the cover section 19 by a plate-like closure member 30.

The sliding button 9 has a coupling piece 31 that can be adjusted towards the adjustment slider 13. The coupling piece 31 of the sliding button 9 is formed in this case by a pushbutton-type coupling slider that is held in the sliding button 9 in such a way as to be adjustable transversely to the second path of movement indicated by double-headed arrow 17. A considerable proportion of the coupling piece 31 is accommodated in the interior of the sleeve-like section 18 of the button in this case. The coupling piece 31 has a disk section 32 from which projects, in the direction of the cover section 19, a cylindrical actuating head 33 that passes through the passage 20 in the cover section 19. A coupling rod 34 projects from the disk section 32 at the side remote from the actuating head 33, the free end of which rod is accommodated in a passage 35 in the closure member 30. Mounted on the coupling rod 34 is a compression spring 36 that loads the coupling piece 31 to its unadjusted starting position, which starting position is shown in FIGS. 2 and 5.

The adjustment slider 13 has a plurality of coupling counterparts that are situated next to one another in the direction of the first path of movement indicated by double-headed arrow 12 and that are provided and configured for coupling to the coupling piece 31 of the second part 9. In the present case these coupling counterparts are formed by the chambers 16. The adjustable coupling piece 31 of the sliding button 9 can be coupled to any of the chambers 16 in the adjustment slider 13, this being done by sliding the free end of the coupling rod 34 into the chamber 16 concerned, which happens if the coupling piece 31 is pressed down, and thus displaced, by hand in the direction of an arrow 37.

The construction of the apparatus 1 is such that, when the sliding button 9 is not actuated—which means that the coupling piece 31 has not been adjusted in the direction of arrow 37, nor has the sliding button 9 been adjusted parallel to the direction of double-headed arrow 17, and hence that both the coupling piece 31 and the sliding button 9 are in their starting positions shown in FIG. 2—, the coupling piece 31 of sliding button 9 and the chambers 16 of the adjustment slider 15 are uncoupled from one another. It is also a fact, in the case of the apparatus 1, that, when the sliding button 9 is actuated—which means that the coupling piece 31 is adjusted in the direction of arrow 37 and the sliding button 9 is adjusted parallel to the direction of double-headed arrow 17—, the coupling piece 31 of the sliding button 9, having been adjusted relative to the adjustment slider 13 as a result of the actuation, is coupled to a chamber 16 in the adjustment slider 13, and the adjustment slider 13 can be or is adjusted along the first path of movement indicated by double-headed arrow 12 by means of the coupling piece 31 of sliding button 9, which has been adjusted relative to the adjustment slider 13 and coupled to the relevant chamber 16 of the adjustment slider 13.

In the apparatus 1, a first limiting stop 38 and a second limiting stop 39 are provided on the housing 2 to limit the adjusting travel available to the sliding button 9 parallel to the direction of the second path of movement indicated by double-headed arrow 17. The first limiting stop 38 and second limiting stop 39 form limiting means 40 for limiting the adjusting travel of the sliding button 9 in this case. The limiting means 40 restrict the adjusting travel available to the sliding button 9 to a fraction of the adjusting travel of the adjustment slider 13. To allow the adjustment slider 13 to be adjusted over the whole of its adjusting travel—which is necessary for allowing the comb device 6 of the apparatus 1 to be adjusted between all the operating positions provided for it—It is provided in the apparatus 1 that the adjustment slider 13 can be or must be adjusted over the whole of its adjusting travel by coupling the coupling piece 31 of the sliding button 9 successively to chambers 16 in the adjustment slider 13 situated next to one another and by adjusting the sliding button 9 a number of times parallel to the direction of the second path of movement indicated by double-headed arrow 17.

Also provided in the apparatus 1 are controllable locking means 41 which are used to lock the adjustment slider 13 against adjustment. The locking means 41 are formed in this case by a locking slider 41 that is adjustably guided in the base part 11. The locking slider 41 here comprises a disk section 42 from which a locking stud 43 projects in the direction of the sliding button 9. The locking stud 43 is provided and configured to cooperate with the chambers 16 in the adjustment slider 13. Projecting from the side of disk section 42 remote from locking stud 43 is a guiding rod 44 on which is mounted a compression spring 45 that loads the locking slider 41 towards its locking position, which is shown in FIGS. 2, 4 and 5. The locking means 41 prevent adjustment of the adjustment slider 13 if the coupling piece 31 of the sliding button 9 and the chambers 16 in the adjustment slider 13 are uncoupled from one another, and hence if the coupling piece 31 is in its starting position shown in FIGS. 1 and 5. As mentioned, the locking slider 41 is a controllable locking means 41, a simple design being achieved in the apparatus 1 in that the locking means 41 can be controlled by the sliding button 9, or to be exact by the coupling piece 31 of the sliding button 9.

Still to be mentioned is the fact that the adjustment slider 13 is provided to allow the comb device 6 of the apparatus 1 to be adjusted. For this purpose, two adjusting arms 46 are each connected to the adjustment slider 13 by a hinge joint 47. Only one of the two adjusting arms 46 can be seen in FIGS. 2 to 5. The two adjusting arms 46 render it possible for the comb device 6 to be adjusted by further adjusting means (not shown). In this connection reference is again made to U.S. Pat. No. 5,898,999 A, wherein such adjustment means are described. The disclosure of this patent is thus incorporated herein by reference.

The method of operation relating to the adjustment of the comb device 6 with the help of the sliding button 9 will be described in more detail below with reference to FIGS. 2 to 5.

FIG. 2 shows a starting position in which the adjustment slider 13 is adjusted to a central one of a total of seven (7) possible operating positions. The adjustment slider 13 is immobilized in this central operating position by the locking stud 43 of the locking slider 41, which means that the two adjusting arms 46 and the further adjustment means (not shown) also cause the comb device 6 to be retained in the operating position to which it has been set.

Let us assume that a user of the apparatus 1 wishes to adjust the comb device 6 to an operating position one step further away from the toothed cutting device 5. To do this, the user will press the sliding button 9, which will mean that the coupling piece 31 is pressed down in the direction of arrow 37, as shown in FIG. 3. As a result of the coupling piece 31 being pressed down in this way, the free end of the coupling rod 34 is thrust into that chamber 16 in the adjustment slider 13 which is situated opposite the coupling rod 34, so that the locking slider 41 is displaced by the free end of the coupling rod 34 of the coupling piece 31 in opposition to the force exerted by the compression spring 45, thus causing the locking stud 43 to be thrust from said chamber 16, as can be seen from FIG. 3. As a result of the locking stud 43 being thrust from the chamber 16 in the adjustment slider 13, the adjustment slider 13 is no longer locked, and as the sequence continues the user can thus displace the sliding button 9 in the manner indicated by an arrow 48 shown in FIG. 4, namely until such time as the sliding button 9 abuts against the first limiting stop 38, as shown in FIG. 4. In the course of this displacement the first compression spring 27 is compressed. The displacement of the sliding button 9 in the direction of arrow 48 causes the comb device 6 to be adjusted accordingly via the two adjusting arms 46.

In the course of the adjustment of the sliding button 9 as just described, the coupling piece 31 of the sliding button 9 is also adjusted, the result of which is not only that the adjustment slider 13 is adjusted, but also that the free end of the coupling rod 34 of the coupling piece 31 is moved off the locking stud 43 of the locking slider 41, as a result of which the force exerted by the compression spring 45 moves the locking slider 41 back towards the adjustment slider 13, thus causing the locking stud 43 of the locking slider 41 to enter the next chamber 16, as can be seen in FIG. 4. Hence the adjustment slider 13 and consequently the comb device 6 are again secured against adjustment by the locking stud 43 of the locking slider 41. At the end of this set of movements, the adjustment of the comb device 6 to its next operating position is completed.

To continue the sequence, the user of the apparatus 1 will release the sliding button 9 and this will cause two processes of movement to occur. Firstly, the force from the compression spring 36 will move the coupling piece 31 back to its starting position in the opposite direction to that indicated by arrow 37, as a result of which the free end of the coupling rod 34 withdraws from the relevant chamber 16 in the first adjustment slider 13. This, however, then causes the first compression spring 27, which was compressed in the course of the previous displacement of the sliding button 9 in the direction indicated by arrow 48, to move the sliding button 9 back again into its starting position, as shown in FIG. 5.

It is clear that by performing the process described above a number of times in succession it is possible for the adjustment slider 13 to be adjusted in two mutually opposed directions, as indicated by double-headed arrow 17, over its full adjusting travel in each case.

It is necessary in the apparatus 1 both for the coupling piece 31 to be deliberately operated and for the sliding button 9 to be deliberately adjusted in order to effect any adjustment of the comb device 6, thus satisfactorily preventing any unwanted adjustment of the comb device 6. It should be noted as particularly advantageous about the apparatus 1 that the sliding button 9 has to perform a considerably smaller adjusting travel than the adjustment slider 13, but it is still possible for the adjustment slider 13 to be adjusted over a large adjusting travel, this giving the advantage that only a passage of small size has to be provided in the housing 2 of the apparatus 1 for the sliding button 9, which in turn gives the advantage that this passage can be sealed relatively simply and satisfactorily, especially as compared with a sliding button that has to be adjusted over virtually the same adjusting travel as the comb device 6 to be adjusted.

In the apparatus 1 shown in FIGS. 1 to 5, the limiting means 40 are formed by the first limiting stop 38 and the second limiting stop 39, which are provided on the housing 2. Rather than by these limiting means 40, the limiting means may alternatively be formed by the projections 23 and 24 and the opposing projections 25 and 26, which then gives the advantage that the limiting means are provided inside the housing 2 of the apparatus 1. Limiting means of other forms may also advantageously be provided inside the housing 2 of the apparatus 1.

FIGS. 6 to 9 show the details essential to the invention of a further apparatus 1. This apparatus 1 also comprises a sliding button 9 in which a coupling piece 31 is accommodated. The sliding button 9 can be adjusted between two limiting stops 38 and 39 on the housing 2 parallel to the second path of movement indicated by double-headed arrow 17. A sealing plate 50 is connected to the sleeve-like section 18 of the button in the interior of the housing. The sealing plate 50 is pressed onto the sleeve-like section 18 of the button.

Controllable locking means 51 for locking the adjustment slider 13 against adjustment are also provided in the apparatus shown in FIGS. 6 to 9. The locking means 51 are formed in this case by two S-shaped extensions 52 and 53 which project from the coupling rod 34 of the coupling piece 31 towards the adjustment slider 13. The adjustment slider 13 has two latching hooks 56 and 57 that are connected thereto by film hinges 54 and 55, respectively, and that are each able to cooperate with latching recesses 58 or 59 provided on stationary parts 60 and 61 of the apparatus. When the coupling piece 31 is in its starting position, as shown in FIGS. 6 and 7, the free ends 62 and 63 of the S-shaped extensions 52 and 53 are situated between the latching hooks 56 and 57 and the adjustment slider 13. As a result, the latching hooks 56 and 57 are locked against adjustment in the direction of arrows 64 and 65 and thus cannot be moved from the latching recesses 58 and 59, which means that the adjustment slider 13 is secured against any adjustment. If on the other hand the coupling piece 31 is adjusted from its starting position shown in FIGS. 6 and 7 to its coupling position shown in FIG. 8, in which case the free end of the coupling rod 34 is coupled to one of a plurality of recesses 66 that are provided in the adjustment slider 13 as coupling counterparts, then the free ends 62 and 63 of the S-shaped extensions 52 and 53 move to a level position shown in FIG. 8 where the free ends 62 and 63 are no longer able to provide any locking for the latching hooks 56 and 57, thus allowing the latching hooks 56 and 57 to be adjusted in the direction of arrows 64 and 65, which means that the latching hooks 56 and 57 can be moved from the latching recesses 58 and 59 and hence that the adjustment slider 13 can be adjusted.

In the apparatus 1 shown in FIGS. 6 to 9, again, the sliding button 9 has an adjusting travel that is substantially smaller that the total travel of the adjustment slider 13, and the adjustment slider 13 can be adjusted over its total adjusting travel by coupling the coupling piece 31 to the adjustment slider 13 and then displacing the sliding button 9 a number of times in succession. In the apparatus 1 shown in FIGS. 6 to 9, an unintentional adjustment of the adjustment slider 13 can again be prevented with a fairly high degree of certainty, and a simple and satisfactory sealing of the passage provided for the sliding button 9 in the housing 2 is possible in a simple manner.

FIG. 10 shows a detail of a further apparatus 1 according to the invention. In this apparatus 1, a sliding button 9 is arranged in a passage 70 in the housing 2 of the apparatus 1 such that the sliding button 9 does not protrude from the housing 2. The sliding button 9 has a coupling piece 72, integral with a main body 71 of the button, which is formed by a coupling extension 72 that tapers into a point. An arm 73 that has resilient properties projects laterally from the main body 71 of the button. In the area of the free end of the arm 73 there is a bearing cylinder 74 integral with the arm 73. The bearing cylinder 74 is housed in a chamber 75 that is formed between the housing 2 and a closure member 76. To this end, the arm 73 passes through a passage 77 provided between the housing 2 and the closure member 76. The sliding button 9 is adjustably guided parallel to the second path of movement indicated by double-headed arrow 17 by means of the bearing cylinder 74 and the chamber 75 and the arm 77 that passes through the passage 77. Pressed onto the main body 71 of the button is a sealing washer 78 which is held against the inside face of the housing 2 by the spring action of the arm 73, thus providing a seal. Also provided in the apparatus 1 shown in FIG. 10 is an adjustment slider 13 that is adjustably guided along the first path of movement indicated by the double-headed arrow 12. The adjustment slider 13 has a plurality of tapering notches 79 as coupling counterparts, with which the tapered free end of the coupling piece 72 can be brought into operative connection.

In the apparatus 1 shown in FIG. 10, again, the sliding button 9 has only a short adjusting travel compared with the long adjusting travel of the adjustment slider 13. The short adjusting travel of the sliding button 9 is defined by two limiting stops 80 and 81 provided as part of the housing 2, which two limiting stops 80 and 81 form limiting means 82, with the advantage that the sliding button 9 only has to be adjusted over a small adjusting travel, whereas the adjustment slider 13 can, by repeated actuation of the sliding button 9, still be adjusted over an adjusting travel that is substantially greater than the adjusting travel of the sliding button 9. The small adjusting travel available to the sliding button 9 has considerable advantages with regard to ensuring that the passage 70 required in the housing 2 of the apparatus 1 for the sliding button 9 is as well sealed as possible. In the apparatus 1 shown in FIG. 10, an unintentional adjustment of the sliding button 9 is also prevented in a very simple yet very reliable way because the sliding button 9 does not protrude from the housing 2.

What was described above with reference to FIGS. 1 to 5 as an apparatus according to the invention was a hair-cutting apparatus. An apparatus according to the invention may, however, be formed by many alternative types of apparatus, such as toothbrushes, shavers, hand-held dictation machines, kitchen appliances, radio recorders, and a variety of other devices.

In the apparatus described above with reference to FIGS. 1 to 5, the adjustment slider 13 is used for adjusting a comb device 6. An adjustment slider of this kind may, however, be alternatively provided for adjusting a potentiometer of an apparatus, and there are obviously many other functions that an adjustment slider of this kind may be provided to perform in an apparatus according to the invention.

Nor is it essential for the second part of the apparatus to take the form of a sliding button, and it may equally well be of some other structural configuration and may be in the form of a pure slider with no button head. As regards the components described above with reference to FIGS. 1 to 10, a second part of the apparatus is in each case simply one button for direct cooperation and adjustment of an adjustment slider. It is not essential for this to be the case because two pushbuttons may also be provided, for example, one of which is provided for direct cooperation with and adjustment of an adjustment slider in one direction and the other for direct cooperation with and adjustment of the adjustment slider in the opposite direction.

In an apparatus according to the invention, it is also possible that two so-called second parts of the apparatus are provided for adjusting an adjustment slider, in which case the two second parts may be formed by two pushbuttons that each have, as a coupling piece, a button slider that is provided with an inclined face extending transversely to the longitudinal direction of the button slider, which inclined face can be brought directly into operative connection with a plurality of coupling counterparts in the adjustment slider to allow the adjustment slider to be displaced, in which case a displacement of the adjustment slider in a first direction of adjustment can be carried out with one of the two pushbuttons and a displacement of the adjustment slider in a second direction of adjustment opposed to the first direction of adjustment can be carried out with the other pushbutton.

In the apparatus components described above with reference FIGS. 1 to 10, a coupling piece is provided on the so-called second part of the apparatus, and a plurality of coupling counterparts are provided in the adjustment slider, with the coupling piece being formed in each case as a part projecting from the second part of the apparatus and the coupling counterparts being formed in each case by recesses or cutouts in the adjustment slider. However, it alternatively possible to have constructions where the second part of the apparatus that is adjustable by hand has a cavity or recess as its coupling piece and the adjustment slider that is adjustable by means of the second part has a plurality of projecting extensions, such as pin-like extensions, as coupling counterparts.

In the apparatus components described above with reference to FIGS. 1 to 10, the adjustment slider is in each case adjustably guided along a first path of movement extending in a straight line. It is not essential for this to be the case because if an adjustment slider of this kind were constructed to extend in a suitably curved shape, it could also be adjustably guided along a first path of movement extending in a curve.

1. An apparatus (1)
having at least one adjustment slider (13) displaceably guided along a first path of movement (12), and
having at least one second part (9) provided for adjusting the adjustment slider (13), which second part (9) is adjustably guided along a second path of movement (17) and can be actuated and adjusted along the second path of movement (17) by hand,
wherein said second part (9) has a coupling piece (31; 72) that is adjustable towards the adjustment slider (13) and can be coupled directly to the adjustment slider (13), and
wherein the adjustment slider (13) has at least one coupling counterpart (16; 66; 79) that is configured for direct coupling to the coupling piece (31; 72) of the second part (9), and
wherein, when the second part (9) is not actuated, the coupling piece (31; 72) of the second part (9) and the at least one coupling counterpart (16; 66; 79) of the adjustment slider (13) are uncoupled from one another, and
wherein, when the second part (9) is actuated, the coupling piece (31; 72) of the second part (9) adjusted towards the adjustment slider (13) as a result of the actuation is directly coupled to a coupling counterpart (16; 66; 76) in the adjustment slider (13), and the adjustment slider (13) can be adjusted along the first path of movement (12) by means of the coupling piece (31; 72) of the second part (9), which coupling piece (31; 72) has been adjusted towards the adjustment slider (13) and directly coupled to the coupling counterpart (16; 66; 79) of the adjustment slider (13).

2. An apparatus (1) as claimed in claim 1,
wherein the adjustment slider (13) comprises a plurality of coupling counterparts (16, 66; 79) situated next to one another in the direction of the first path of movement (12), and
wherein the adjustable coupling piece (31; 72) of the second part (9) can be directly coupled to each of the coupling counterparts (16; 66; 79) in the adjustment slider (13).

3. An apparatus (1) as claimed in claim 2, wherein
limiting means (40; 82) are provided for limiting the adjusting travel for the second part (9) in the direction of the second path of movement (17), and
wherein the adjusting travel for the second part (9) is limited to a fraction of the adjusting travel of the adjustment slider (13) with the help of the limiting means (40; 82), and
wherein the adjustment slider (13) can be adjusted over the whole of its total adjusting travel by coupling the coupling piece (31; 72) of the second part (9) successively to the coupling counterparts (16; 66; 79) in the adjustment slider (13) that are situated next to one another and by adjusting the second part (9) a number of times in the direction of the second path of movement (17).

4. An apparatus (1) as claimed in claim 3, wherein
a starting position is defined for the second part (9), and
wherein spring means (29) are provided that cooperate with the second part (9) and load the second part (9) in the direction of its starting position.

5. An apparatus (1) as claimed in claim 1, wherein
controllable locking means (41; 51) are provided to lock the adjustment slider (13) against adjustment, which locking means (41; 51) prevent adjustment of the adjustment slider (13) if the coupling piece (31) of the second part (9) and the at least one coupling counterpart (16; 66) in the adjustment slider (13) are uncoupled from one another.

6. An apparatus (1) as claimed in claim 4, wherein
the locking means (41; 51) can be controlled by the second part.

7. An apparatus (1) as claimed in claim 5, wherein
the locking means (41; 51) can be controlled by the coupling piece (31) of the second part (9).

8. An apparatus (1) as claimed in claim 1, wherein
the second part (9) is in the form s of a sliding button (9) that can be adjusted along the second path of movement (17), and
wherein the coupling piece (31) of the sliding button (9) is formed by a pushbutton-type coupling slider (31) that is held on the sliding button (9) so as to be adjustable transversely to the second path of movement (17).
